(19) United States
(12) Patent Application Publication
(10) Pub. No.: US 2011/0247164 A1
(43) Pub. Date: Oct. 13, 2011

(54) Hand implement for bucket use

(76) Inventor: Blake Busch, Morehead City, NC (US)

(21) Appl. No.: 12/798,700

(22) Filed: Apr. 9, 2010

(51) Int. Cl. B05C 17/10; B05C 11/04

(52) U.S. Cl. 15/245.1; 222/1

(57) ABSTRACT

A hand implement for bucket use including a handle for gripping by a user to manipulate the implement for bucket use, the handle extending longitudinally and defining a first handle axis; and a blade formed from a rigid material and extending laterally outwardly from the handle, the blade including two side edges extending laterally outwardly from the handle in a contoured manner about a through-blade axis, the blade including a working edge extending between the two side edges, the working edge being curved about a second handle axis with a predetermined radius of curvature, the second handle axis extending parallelly with the first handle axis, and disposed from the first handle axis by a distance equal to the radius of curvature, the working edge extending along the cross-blade axis for blade fitment substantially against an inner bucket wall.

### BACKGROUND OF THE INVENTION

The present invention relates broadly to task-dedicated handheld tools and more particularly to a hand implement for bucket use, also known as a bucket multitool.

In the construction industry, semi-flowable material such as grout or Thin Set mortar, is used when laying tile. In order to handle the material, a trowel or other type scraping tool is used. Typically, the trowel includes a handle portion and a working blade portion. The working blade portion may have one of several configurations and typically, the configurations are convenient for laying the grout to the tile, substrate or both.

Such semi-flowable construction material typically comes in five-gallon buckets of the type having a generally cylindrical inner cavity formed by a generally cylindrical cavity wall approximately 11.75 inches in diameter having an access opening at one end and substantially flat bottom portion disposed oppositely from the access opening.

In order to use the semi-flowable construction material in an efficient manner, it is desirable to be able to scrape all of the contents out of the five-gallon bucket. This can be a problem based on the configuration of the trowel or other type of tool being used to remove the material. Further, the material may end up being removed by hand, i.e. without the use of any supporting tool. Additionally, when not in use, there is no particularly efficient place to store a trowel in the bucket for later use since the shapes of the blades are typically incompatible with any support structure provided in the construction environment.

It would therefore be desirable if a multipurpose tool were provided that could be used when mixing and applying Thin-Set mortar or grout by hand, scraping the sides of the bucket, scooping the contents of the bucket onto the tile, brick or other substrate as well as removal of the final contents of the bucket.

### SUMMARY OF THE INVENTION

It is accordingly an object of the present invention to provide a hand implement for bucket use that is useful when mixing and applying thin-set mortar or grout by hand.

It is another object of the present invention to provide such a hand implement that is useful when scraping the inside wall of the bucket.

It is another object of the present invention to provide such a multipurpose implement that is useful in scooping the contents of the bucket out of the bucket for use on a substrate.

It is another object of the present invention to provide an implement that will facilitate easy removal of the remaining contents of a five-gallon bucket.

To those ends the present invention is directed to a hand implement for bucket use, the bucket including at least one wall delimiting an inner cavity. The implement includes a body having a handle for gripping by a user to manipulate the implement for bucket use, the handle extending longitudinally and defining a first handle axis; and a blade formed from a rigid material and extending laterally outwardly from the handle. The blade defines a cross-blade axis substantially normal to the first handle axis, and a through-blade axis substantially normal to the first handle axis and the cross-blade axis. The blade includes two side edges extending laterally outwardly from the handle in a contoured manner about the through-blade axis, and includes a working edge extending between the two side edges. The working edge is curved about a second handle axis with a predetermined radius of curvature, the second handle axis extending parallelly with the first handle axis and disposed from the first handle axis by a distance equal to the radius of curvature. The working edge extends along the cross-blade axis for blade fitment substantially against an inner bucket wall.

Preferably, the radius of curvature of the working edge is in the range of about 5.75 inches and about 6 inches. It is further preferred that the radius of curvature of the working edge approximates the radius of curvature of walls forming the inner cavity of the bucket. In addition, it is preferred that the radius of curvature of the working edge is substantially constant from a first side edge to a second side edge. Preferably, the working edge is curved about the handle axis with a predetermined radius of curvature while extending along the cross-blade axis for defining a scoop region bounded by the side edges and the handle and for general blade fitment substantially against the inner bucket wall.

It is preferred that the blade include a tang portion extending laterally away from the side edges and the handle extends along the tang portion. It is further preferred that the blade include a blade plate extending away from the tang and intermediate the side edges wherein the blade plate includes a generally planar region intermediate the tang and the scoop region.

Preferably, the scoop region of the blade plate includes an intermediate curved region having a side edge formed with a first radius of curvature about the through-blade axis and a distal curved region having a side edge formed with a second radius of curvature about the through-blade axis with the intermediate curved region disposed adjacent the generally planar region and the distal curved region carrying the working edge, wherein the combination of the intermediate curved region and the distal curved region form the scoop region.

The hand implement of the present invention can also be described as a hand implement for bucket use, the bucket defining an inner cavity extending along a central bucket axis, wherein the hand implement includes a body having a handle for gripping by a user to manipulate the implement for bucket use, the handle extending longitudinally and defining a first handle axis; and a blade formed from a rigid material and extending laterally outwardly from the handle. the blade defines a cross-blade axis substantially normal to the handle axis and a through-blade axis substantially normal to the handle axis and the cross-blade axis. The blade includes two side edges extending laterally outwardly from the handle in a contoured manner about the through-blade axis. The blade further includes a working edge extending between the two side edges, with the working edge being curved about a second handle axis with a predetermined radius of curvature. The second handle axis extends generally parallelly with the first handle axis, and is disposed from the first handle axis by a distance equal to the radius of curvature. The working edge extends along the cross-blade axis for blade fitment substantially against an inner bucket wall, with the second handle axis generally coincident with the central bucket axis, and wherein the radius of curvature of the working edge approximates the radius of curvature of at least one wall forming the inner cavity of the bucket.

Preferably, the radius of curvature of the side edges and the radius of curvature of the working edge is in the range of about 5.75 inches and about 6 inches. It is preferred that the radius of curvature of the working edge is substantially constant from a first side edge to a second side edge. It is preferred that the working edge is curved about the handle axis with a predetermined radius of curvature while extending along the cross-blade axis for defining a scoop region bounded by the side edges and the handle and for general blade fitment substantially against an inner bucket wall.

Preferably, the blade includes a tang portion extending laterally away from the side edges and the handle extends along the tang portion. Further, it is preferred that the blade includes a blade plate extending away from the tang and intermediate the side edges wherein the blade plate includes a generally planar region intermediate the tang and the scoop region. It is likewise preferred that the scoop region of the blade plate includes an intermediate curved region having a side edge formed with a first radius of curvature about the through-blade axis and a distal curved region having a side edge formed with a second radius of curvature about the through-blade axis with the intermediate curved region disposed adjacent the generally planar region and the distal curved region carrying the working edge, wherein the combination of the intermediate curved region and the distal curved region formed the scoop region.

The present invention is also directed to a method for using the present hand implement. To that end the present invention is directed to a method for manipulating a construction substance in a bucket using a hand implement including the steps of:
moving a hand implement into a generally vertically-oriented position against an inner bucket wall, the hand implement having a body including a handle for gripping by a user to manipulate the implement for bucket use, the handle extending longitudinally and defining a handle axis; and a blade formed from a rigid material and extending laterally outwardly from the handle, the blade defining a cross-blade axis substantially normal to the handle axis and a through-blade axis substantially normal to the handle axis and the cross-blade axis, the blade including two side edges extending laterally outwardly from the handle in a contoured manner about the through-blade axis, the blade including a working edge extending between the two side edges, the working edge being curved about a second handle axis with a predetermined radius of curvature, the second handle axis extending parallelly with the first handle axis, and disposed from the first handle axis by a distance equal to the radius of curvature, with the working edge extending along the cross-blade axis for defining a scoop region bounded by the side edges and the handle and for general form-fitment against an inner bucket wall, with the handle axis generally parallel with the central bucket axis;
moving the implement toward the base of the bucket, thereby moving any construction substance ahead of the implement toward the bottom of the bucket;
moving an amount of construction material laterally toward the center of the bucket using the hand implement; and
manipulating the implement for retention of an amount of construction substance on the blade in the scoop region.

Preferably, the method further includes the step of removing a predetermined amount of construction material from the bucket using the scoop region of the implement.

It is preferred that the present method also include the stop of removing a predetermined amount of construction material from the bucket using the scoop region of the implement wherein the scoop region is formed by curved side blade portions, extending away from the cross-blade axis with a predetermined radius of curvature.

Preferably, the method further includes the step of removing a predetermined amount of construction material from the bucket using the scoop region of the implement wherein the scoop region is formed by curved side blade portions, extending away from the cross-blade axis with a predetermined radius of curvature with the radius of curvature being in the range of about 5.75 inches and about 6 inches. It is preferred that the method include the step of removing a predetermined amount of construction material from the bucket using the scoop region of the implement wherein the radius of curvature of the side edges and the radius of curvature of the working edge are substantially constant from a first side edge to a second side edge.

It is preferred that the present method further include the step of parking the hand implement against the bucket wall with at least a portion of the blade against the bucket wall in a form fitting manner.

### BRIEF DESCRIPTION OF THE DRAWINGS

FIG. 1 is a top plan view of a hand implement for bucket use according to one preferred embodiment of the present invention;

FIG. 2 is another top plan view of the pendant and illustrated in FIG. 1;

FIG. 3 is a bottom plan view of the hand implement illustrated in FIG. 2;

FIG. 4 is a front view of the hand implement illustrated in FIG. 3;

FIG. 5 is a side view of the hand implement illustrated in FIG. 1;

FIG. 6 is a front perspective view of the hand implement illustrated in FIG. 2

FIG. 7 is a front perspective view of the hand implement illustrated in FIG. 1; and

FIG. 8 is an environmental view of a hand implement for bucket use as illustrated in FIG. 1 disposed within a five-gallon bucket, with the bucket broken open for clarity.

### DESCRIPTION OF THE PREFERRED EMBODIMENT

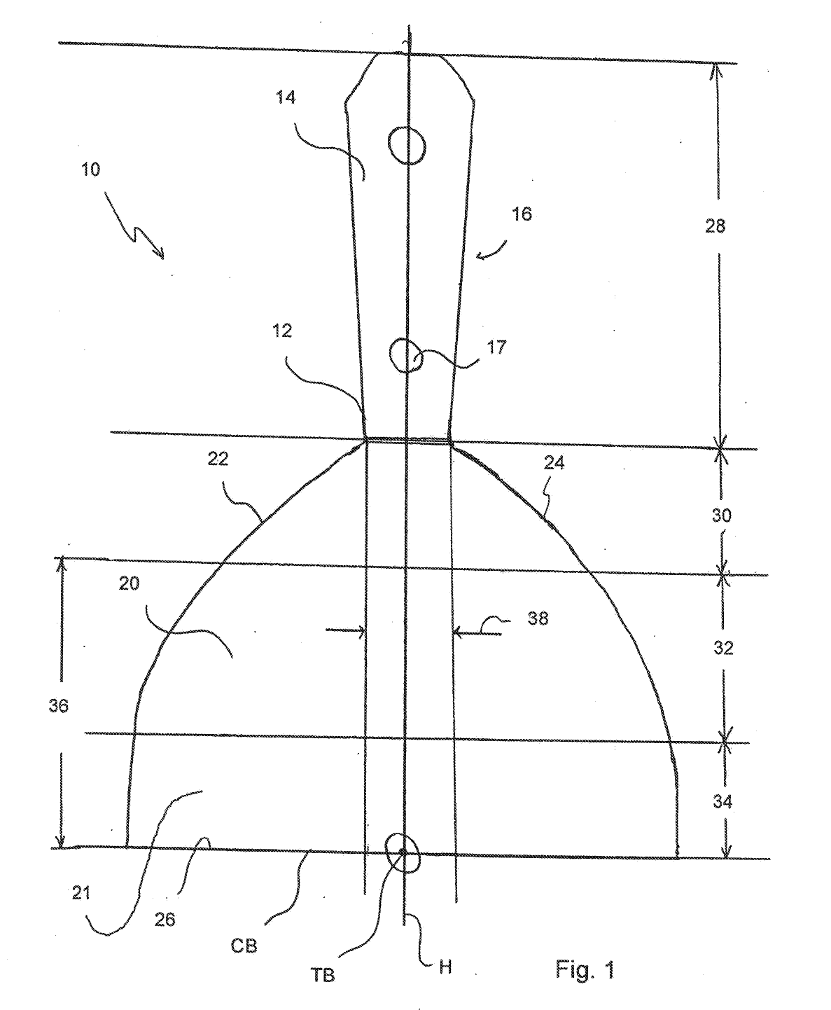

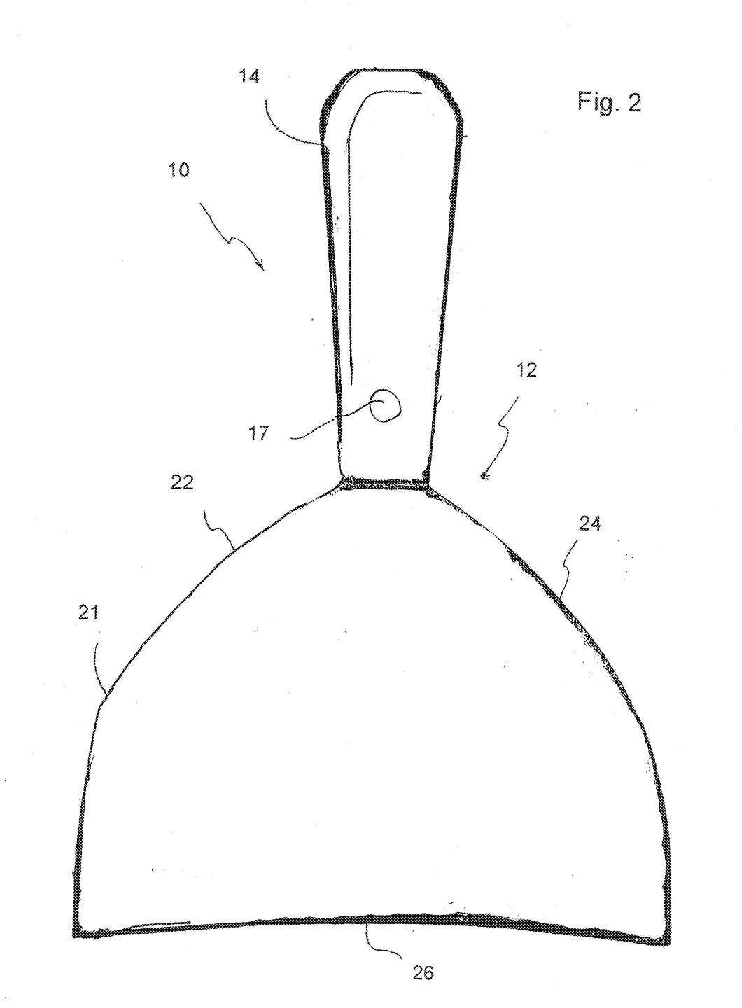

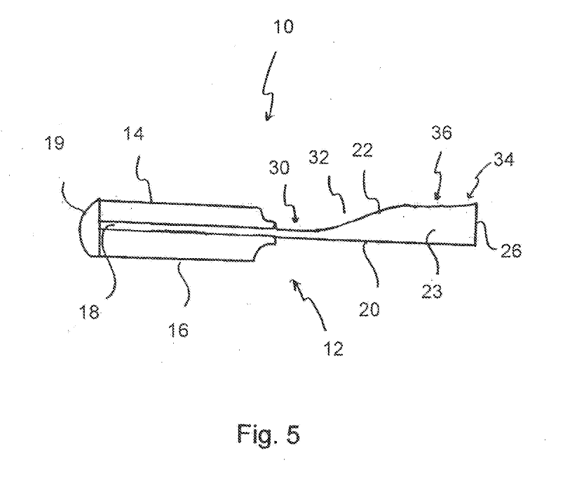

Turning now the drawings and, more particularly to FIGS. 1 and 2, the hand implement bucket use is illustrated generally at 10 and includes a body 12 having a two portion handle, 14, 16 and a blade plate 20 extending outwardly therefrom. As seen in FIG. 5, the blade plate 20 extends into a tang portion 18 that is sandwiched between two handle portions 14, 16 including a first handle portion 14 and a second handle portion 16. An end cap 19 formed as a generally hemispherical dome-like structure may be placed on the end of the handle 14, 16 at an end opposite the blade plate 20. The handle is generally elongate and configured for gripping by a user. The handle portions 14, 16 are mounted to the tang 18 using rivets 17, as seen in FIGS. 1 and 5. The handle portions 14, 16 may be made from wood, plastic, rubber or other such suitable handle material.

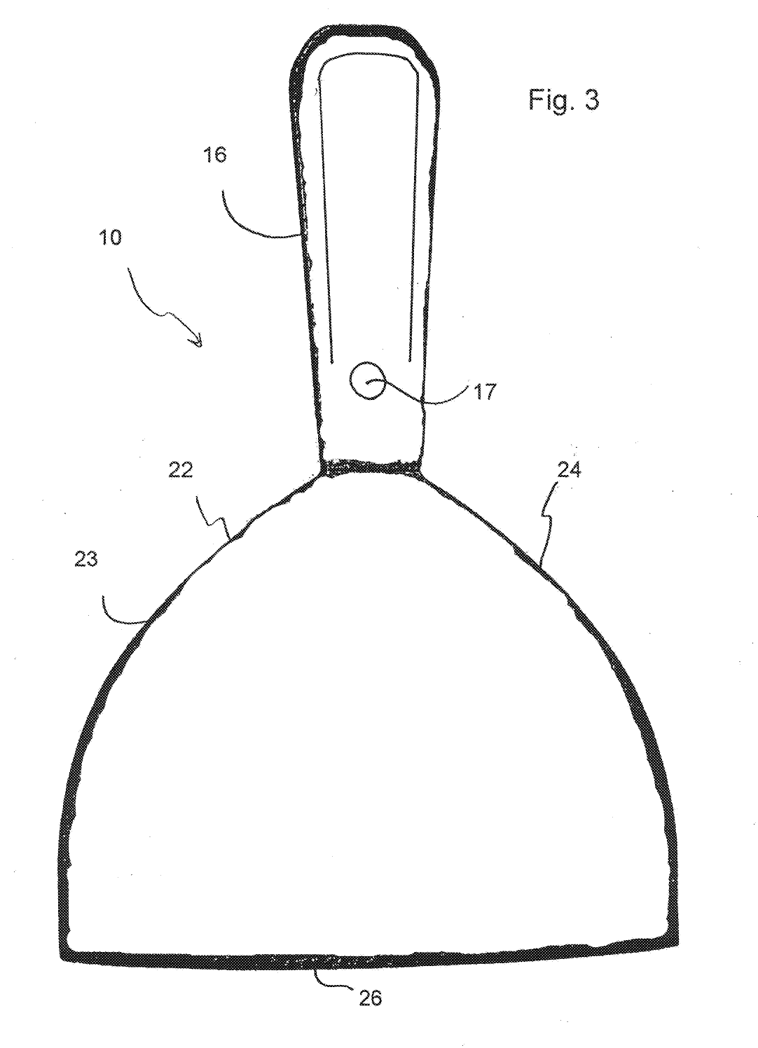

With reference to FIGS. 1 and 2, the blade plate 20 projects outwardly laterally away from the handle 14, 16. The handle, 14, 16 defines an elongate handle axis indicated at H in FIG. 1 and divides the implement 10 in half as seen from a top plan view such as that of FIG. 1. The blade plate 20 is formed with curved side edges 22, 24 that extend in a curved manner away from the handle portions 14, 16 in a symmetric, predetermined curve, as seen from above (FIG. 2) or below (FIG. 3). A working edge 26 extends between the distal ends of the side edges 22, 24 to define the general blade shape as seen from above in FIG. 1. The working edge 26 defines a cross-blade axis indicated at CB in FIG. 1. The cross-blade axis CB is disposed at 90 degrees from the handle axis H. A through-blade axis TB extends into the page as seen in FIG. 1 and through the junction of the handle axis H with the cross blade axis CB. Together, the handle axis H, the cross blade axis CB and the three-blade axis TB form a Cartesian Coordinate System around which the implement 10 of the present invention may be viewed.

The blade plate 20 includes an inner surface or working surface 21 as seen in FIGS. 1 and 2 and a back surface 23 as seen in FIG. 3. The blade plate 20 is formed from a relatively thin, rigid material as seen in FIG. 5. As will be seen in greater detail hereinafter it is important that the blade plate 20 be made from rigid material so as not to flex during operation and distribute construction material in an undesired manner.

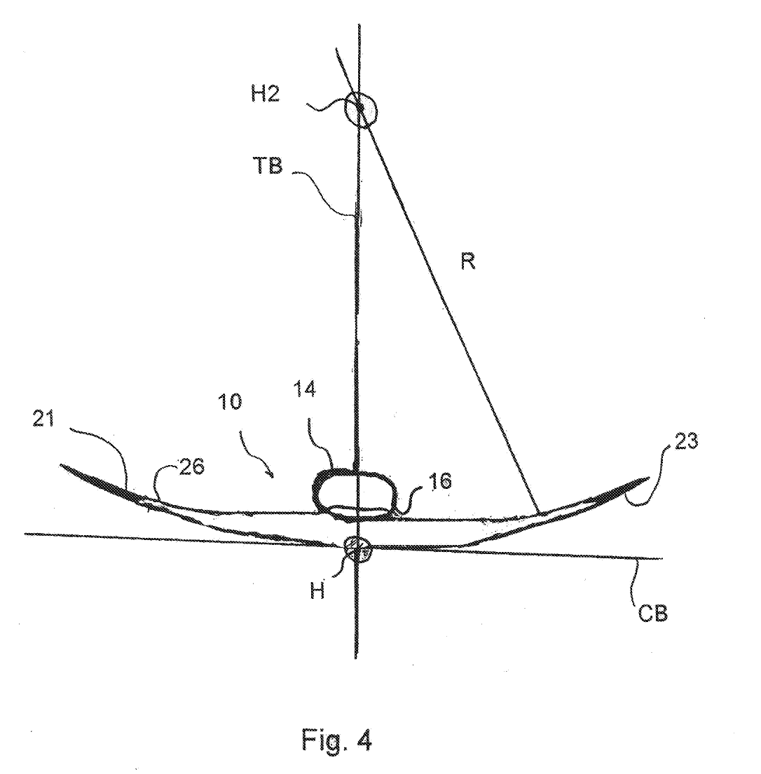

As seen in FIGS. 1, 4 and 5, the blade plate 20 for the present implement 10 is curved in a predetermined manner so as to provide easy bucket use as well as a scooping action that has been heretofore unknown with prior trial structures. With reference to FIG. 1, it can be seen that the blade plate is divided into several distinct regions including a handle or tang region 28, a generally planar region 30, a medium curved region 32 and a distal region 34. Additionally, an axial region 38 extends across the blade plate from the handle region 28 to the working edge 26 along the general width of the handle. While the axial region appears generally planar, it should be noted that the curvature applied to the blade is so slight that a small slice of any particular curved region will appear planar if the slice is small enough, which is the case with respect to the axial region 38. Additionally, the planar region 30 appears generally planar as seen in FIG. 5 yet also includes a minimum curvature. The medium curve region 32 is so called due to the medium curvature applied to the blade plate 20 about an axis parallel to the through blade axis TB, as seen in FIG. 4.

When viewed from above, the side edges 22, 24 in the planar region are formed with a first radius of curvature about the three-blade axis TB. The radius of curvature changes and increases when in the medium curvature region 32 of the blade plate. Further, the radius of curvature varies within the distal region 34 such that the side edges 22, 24 within the distal region 34 are substantially lineally extending with respect to the handle axis H.

With continued reference to FIG. 4, the blade plate 20 is curved with a predetermined radius about a bucket axis generally parallel to the handle axis H and indicated at H2 in FIG. 4. The bucket axis H2 is disposed a predetermined distance R from the handle axis H along the through-blade axis TB, to thereby define a radius of curvature of the blade plate 20. It is preferred that the radius of curvature R of the blade plate 20 conform to the inner wall surface of a five-gallon bucket. R values are generally in the range of 5.75 inches to 6.00 inches. Advantages to such construction will be revealed in greater detail hereinafter.

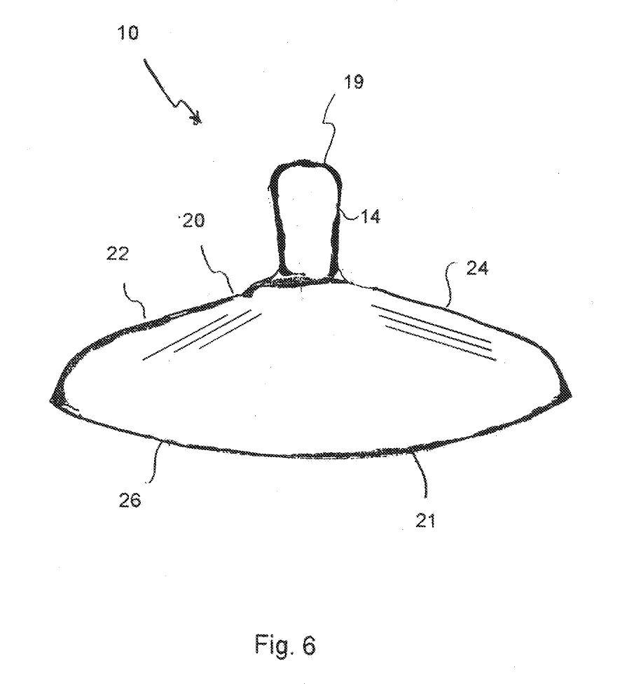

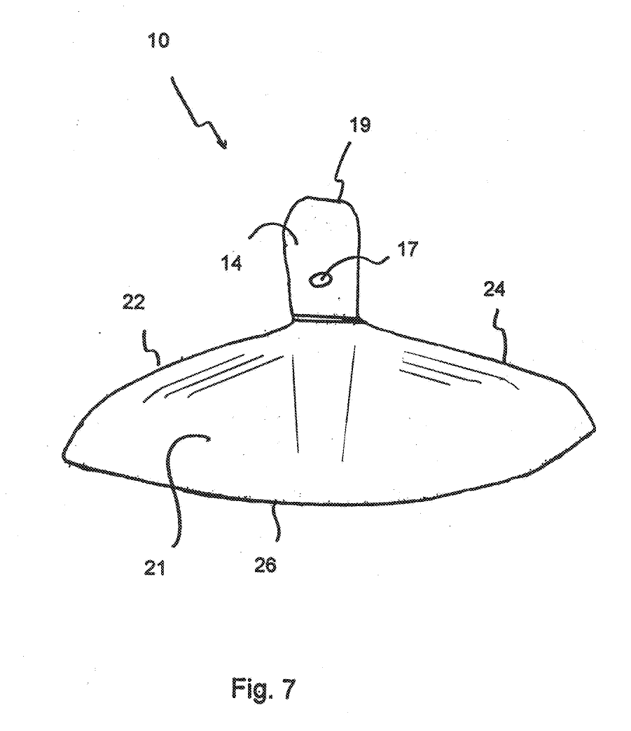

The distal region 34 enjoys the most curvature since the distal region 34 represents the widest portion of the blade plate 20. The side edges 20 and 24 are most curved within the medium curvature region 32 and tend to form a relationship almost parallel with the handle axis H in the distal region 34. Such a structure defines a scoop region 36 encompassing the middle curved region 32 and the distal region 34. The scoop region 36 is useful when using the hand implement 10 according to the method of the present invention which will be explained in greater detail hereinafter. FIGS. 6 and 7 reveal a perspective view of the curvature of the hand implement of the present invention. It should be noted that the working edge 26 is straight across, extends coincident with the cross blade axis CB and is not curved as appears in FIG. 6, such appearance being attributable to perspective distortion of the illustration.

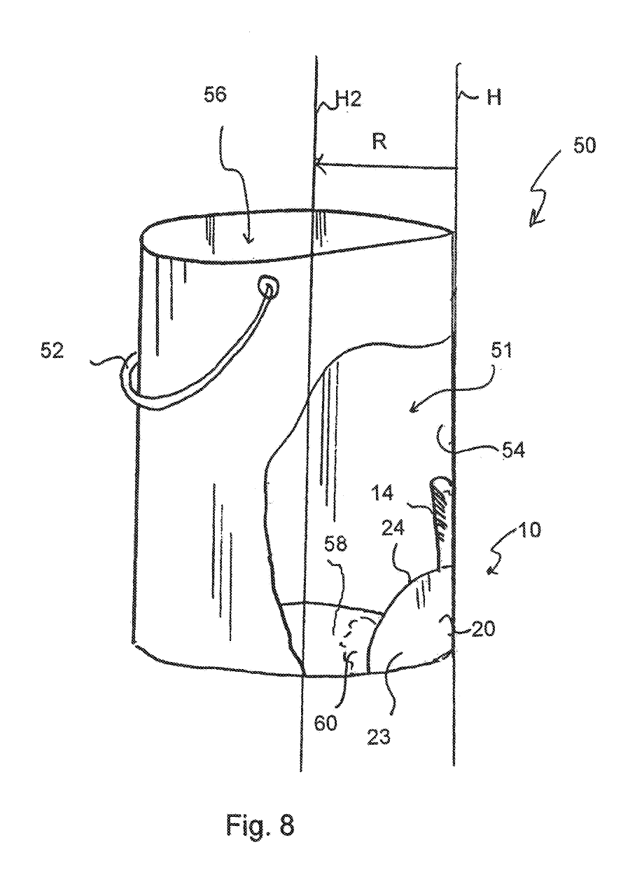

As stated above, the radius of curvature of a blade plate 20 is in the range of about 5.75 inches to about 6.00 inches which conforms generally to the radius of curvature of the inner cavity of a five-gallon bucket, as seen in FIG. 8.

Therefore, when the hand implement 10 according to the present invention is placed in a five-gallon bucket 50 vertically, i.e. with the back surface 22 of the curved blade plate 20 against the wall of the bucket 50 and the handle 14, 16 projecting upwardly toward the access opening 56, a general shape conformance is experienced between the blade plate 20 and the inner wall 54 of the five-gallon bucket 50 such that if the blade plate 20 is scraped down the inner wall 54 of the bucket 50, it will come in contact with substantially all construction material content along the bucket wall 54 between the distal end portions of the side edges 22, 24 along the working edge 26 of the present hand implement 10.

With continued reference to FIG. 8, and according to the method of the present invention, a five-gallon bucket 50 is illustrated broken open to reveal the hand implement 10 disposed in the bucket cavity 51. The five-gallon bucket 50 is formed from a generally cylindrical bucket wall 54 and includes a user's operating handle 52 mounted to the outer surface thereof. An access opening 56 is formed in one end of the bucket 50 and a generally planar base 58 is disposed at the bottom of the bucket 50 oppositely from the access opening 56. An amount of construction material 60 may be disposed within the bucket.

According to the method of the present invention, the hand implement may be placed within the bucket 50 with the handle extending along the handle axis H a predetermined distance R from the bucket axis H2. As described above, the blade plate 20 is formed with a radius of curvature equal to R, i.e. the radius of the five-gallon bucket. Therefore, the blade plate 20 will fit substantially against the curved inner bucket wall 54.

According to the method, the blade is moved in a reciprocatory or vertical manner to scrape any construction material 60 from the inner wall 54 of the bucket 50. The handle then may be used to move the working edge 26 across the bottom surface 58 of the bucket to push any construction material 60 toward the center of the bucket. The implement may then be angularly manipulated and moved across the bottom 58 of the bucket in order to place a certain amount of construction material 60 within the scoop region 36 of the hand implement 10 as seen in FIGS. 1 and 5. With continued reference to FIG. 8, a predetermined amount of construction material may be removed from the bucket using the scoop region 38 of the implement 10. Getting remnants of construction material out of the five-gallon bucket may be accomplished by scraping all the edges or sides of the bucket by holding the hand implement 10 vertically rather than horizontally to get the bucket sides clean, then tipping bucket 50 over and using back side of tool to pull remaining contents out. The hand implement may also be used as a scoop to push contents up and out. When not in use, the blade may be placed in the bucket 50 with the blade plate 20 against the bucket wall 54 thereby standing the implement 10 vertically with respect to the handle axis H and out of the way of a user until it is needed once more.

By the above, the present invention provides a hand implement for bucket use forming a multipurpose tool that can be used in many ways. When mixing and applying construction materials, scraping the sides of the bucket, scooping the contents of the bucket onto the tile, brick, or other substrate, the hand implement 10 of the present invention can hold much more than conventional straight blade commonly used in these trades.

It will therefore be readily understood by those persons skilled in the art that the present invention is susceptible of a broad utility and application. While the present invention is described in all currently foreseeable embodiments, there may be other, unforeseeable embodiments and adaptations of the present invention, as well as variations, modifications and equivalent arrangements, that do not depart from the substance or scope of the present invention. The foregoing disclosure is not intended or to be construed to limit the present invention or otherwise to exclude such other embodiments, adaptations, variations, modifications and equivalent arrangements, the present invention being limited only by the claims appended hereto and the equivalents thereof.

I claim:

1. A hand implement for bucket use, the bucket including at least one wall delimiting an inner cavity, the implement comprising:
a body including:
a handle for gripping by a user to manipulate the implement for bucket use, the handle extending longitudinally and defining a first handle axis; and
a blade formed from a rigid material and extending laterally outwardly from the handle, the blade defining a cross-blade axis substantially normal to the first handle axis, and a through-blade axis substantially normal to the first handle axis and the cross-blade axis, the blade including two side edges extending laterally outwardly from the handle in a contoured manner about the through-blade axis, the blade including a working edge extending between the two side edges, the working edge being curved about a second handle axis with a predetermined radius of curvature, the second handle axis extending parallelly with the first handle axis, and disposed from the first handle axis by a distance equal to the radius of curvature, the working edge extending along the cross-blade axis for blade fitment substantially against an inner bucket wall.

2. A hand implement according to claim 1 wherein the radius of curvature of the working edge is in the range of about 5.75 inches and about 6 inches.

3. A hand implement according to claim 1 wherein the radius of curvature of the working edge approximate the radius of curvature of walls forming the inner cavity of the bucket.

4. A hand implement according to claim 1 the radius of curvature of the working edge is substantially constant from a first side edge to a second side edge.

5. A hand implement according to claim 1 wherein the working edge is curved about the handle axis with a predetermined radius of curvature while extending along the cross-blade axis for defining a scoop region bounded by the side edges and the handle and for general blade fitment substantially against an inner bucket wall.

6. A hand implement according to claim 5 wherein the blade includes a tang portion extending laterally away from the side edges and the handle extends along the tang portion.

7. A hand implement according to claim 6 wherein the blade includes a blade plate extending away from the tang and intermediate the side edges wherein the blade plate includes a generally planar region intermediate the tang and the scoop region.

8. A hand implement according to claim 6 wherein the scoop region of the blade plate includes an intermediate curved region having a side edge formed with a first radius of curvature about the through-blade axis and a distal curved region having a side edge formed with a second radius of curvature about the through-blade axis with the intermediate curved region disposed adjacent the generally planar region and the distal curved region carrying the working edge, wherein the combination of the intermediate curved region and the distal curved region formed the scoop region.

9. A hand implement for bucket use, the bucket defining an inner cavity extending along a central bucket axis, the implement comprising:
a body including:
a handle for gripping by a user to manipulate the implement for bucket use, the handle extending longitudinally and defining a first handle axis; and
a blade formed from a rigid material and extending laterally outwardly from the handle, the blade defining a cross-blade axis substantially normal to the handle axis and a through-blade axis substantially normal to the handle axis and the cross-blade axis, the blade including two side edges extending laterally outwardly from the handle in a contoured manner about the through-blade axis, the blade including a working edge extending between the two side edges, the working edge being curved about a second handle axis with a predetermined radius of curvature, the second handle axis extending parallelly with the first handle axis, and disposed from the first handle axis by a distance equal to the radius of curvature, the working edge extending along the cross-blade axis for blade fitment substantially against an inner bucket wall, with the second handle axis generally coincident with the central bucket axis, and wherein the radius of curvature of the working edge approximates the radius of curvature of walls forming the inner cavity of the bucket.

10. A hand implement according to claim 9 wherein the radius of curvature of the side edges and the radius of curvature of the working edge is in the range of about 5.75 inches and about 6 inches.

11. A hand implement according to claim 10 wherein the radius of curvature of the working edge is substantially constant from a first side edge to a second side edge.

12. A hand implement according to claim 9 wherein the working edge is curved about the handle axis with a predetermined radius of curvature while extending along the cross-blade axis for defining a scoop region bounded by the side edges and the handle and for general blade fitment substantially against an inner bucket wall.

13. A hand implement according to claim 12 wherein the blade includes a tang portion extending laterally away from the side edges and the handle extends along the tang portion.

14. A hand implement according to claim 13 wherein the blade includes a blade plate extending away from the tang and intermediate the side edges wherein the blade plate includes a generally planar region intermediate the tang and the scoop region.

15. A hand implement according to claim 14 wherein the scoop region of the blade plate includes an intermediate curved region having a side edge formed with a first radius of curvature about the through-blade axis and a distal curved region having a side edge formed with a second radius of curvature about the through-blade axis with the intermediate curved region disposed adjacent the generally planar region and the distal curved region carrying the working edge, wherein the combination of the intermediate curved region and the distal curved region formed the scoop region.

16. A method for manipulating a construction substance in a bucket using a hand implement includes the steps of:
moving a hand implement into a generally vertically-oriented position against an inner bucket wall, the hand implement having a body including a handle for gripping by a user to manipulate the implement for bucket use, the handle extending longitudinally and defining a handle axis; and a blade formed from a rigid material and extending laterally outwardly from the handle, the blade defining a cross-blade axis substantially normal to the handle axis and a through-blade axis substantially normal to the handle axis and the cross-blade axis, the blade including two side edges extending laterally outwardly from the handle in a contoured manner about the through-blade axis, the blade including a working edge extending between the two side edges, the working edge being curved about a second handle axis with a predetermined radius of curvature, the second handle axis extending parallelly with the first handle axis, and disposed from the first handle axis by a distance equal to the radius of curvature, with the working edge extending along the cross-blade axis for defining a scoop region bounded by the side edges and the handle and for general form-fitment against an inner bucket wall, with the handle axis generally parallel with the central bucket axis;
moving the implement toward the base of the bucket, thereby moving any construction substance ahead of the implement toward the bottom of the bucket;
moving an amount of construction material laterally toward the center of the bucket using the hand implement; and
manipulating the implement for retention of an amount of construction substance on the blade in the scoop region.

17. A method for manipulating a construction substance in a bucket according to claim 16 and further comprising the step of removing a predetermined amount of construction material from the bucket using the scoop region of the implement.

18. A method for manipulating a construction substance in a bucket according to claim 16 and further comprising the step of removing a predetermined amount of construction material from the bucket using the scoop region of the implement wherein the scoop region is formed by curved side blade portions, extending away from the cross-blade axis with a predetermined radius of curvature.

19. A method for manipulating a construction substance in a bucket according to claim 16 and further comprising the step of removing a predetermined amount of construction material from the bucket using the scoop region of the implement wherein the scoop region is formed by curved side blade portions, extending away from the cross-blade axis with a predetermined radius of curvature with the radius of curvature being in the range of about 5.75 inches and about 6 inches.

20. A method for manipulating a construction substance in a bucket according to claim 16 and further comprising the step of removing a predetermined amount of construction material from the bucket using the scoop region of the implement wherein the radius of curvature of the side edges and the radius of curvature of the working edge are substantially constant from a first side edge to a second side edge.

21. A method for manipulating a construction substance in a bucket according to claim 16 and further comprising the step of parking the hand implement against the bucket wall with at least a portion of the blade against the bucket wall in a form fitting manner.
